(19) United States
(12) Patent Application Publication
(10) Pub. No.: US 2006/0095181 A1
(43) Pub. Date: May 4, 2006

(54) Process for assessing a rotational movement of a motor vehicle

(76) Inventor: Abtin Darvish, Wuppertal (DE)

Correspondence Address: DELPHI TECHNOLOGIES, INC., M/C 480-410-202, PO BOX 5052, TROY, MI, 48007, US

(21) Appl. No.: 11/250,168

(22) Filed: Oct. 13, 2005

(30) Foreign Application Priority Data
Nov. 3, 2004 (EP) 04026078.8

(51) Int. Cl. G06F 7/00; B60G 17/016

(52) U.S. Cl. 701/38

(57) ABSTRACT

The invention relates to a process for assessing a rotational movement, in particular a rolling or rollover movement, of a motor vehicle, in which the angular velocity of the vehicle is measured several times about at least one vehicle axis, in particular about the longitudinal axis, the horizontal transverse axis and/or the vertical transverse axis of the vehicle, the angular acceleration of the vehicle about the at least one vehicle axis is ascertained from two measured angular velocities, and the ascertained angular acceleration is taken into account when assessing the rotational movement. The invention also relates to a device for assessing a rotational movement, in particular a rolling or rollover movement, of a motor vehicle, and to a process for activating a vehicle safety system.

### TECHNICAL FIELD

The invention relates to a process for assessing a rotational movement, in particular a rolling or rollover movement, of a motor vehicle, in which the angular velocity of the vehicle is measured several times about at least one vehicle axis, in particular about the longitudinal axis, the horizontal transverse axis and/or the vertical transverse axis of the vehicle.

### BACKGROUND OF THE INVENTION

Such a process is known in principle. It is used, for example to recognise dangerous rolling or rollover movements of the motor vehicle, in order to be able to optionally introduce suitable safety measures, for example the moving out of a roll bar and/or the tightening of safety belts.

To ascertain the rolling or rollover movement, the angular velocity of the vehicle about its longitudinal axis and the lateral and vertical acceleration of the vehicle are conventionally measured. The angle of roll or angle of rotation of the vehicle is ascertained by a numerical integration of the rolling rate or angular velocity and optionally corrected by the measured acceleration values in lateral or vertical direction.

Typical rolling or rollover movements, such as for example a rolling movement of a motor vehicle over a crash barrier or a ramp, proceed comparatively slowly. Conventionally the angle of roll of the motor vehicle is increased in such cases in about 1 to 2 seconds from 0° to 90°, that is the vehicle tilts in 1 to 2 seconds from its normal street position onto the side. Since during such a slow rolling movement, a comparatively low risk of head injuries to the vehicle occupants exists, a detection time of about 600 to 700 ms, which corresponds to an angle of roll of about 30° to 40°, is sufficient to activate, for example a roll bar or airbag.

However, more rapid rolling or rollover movements, as may occur during the intake of sand, that is, during an at least partial deviation of the vehicle from a fixed carriageway, or in the case of contact of the vehicle with a kerb edge, have proved to be problematic. To effectively avoid injuries of the vehicle occupants, in such cases reliable detection of the rotational movement is desirable even for tilting of the vehicle by less than 10°. This requires a rapid detection of the rolling or rollover movement in the region of 100 to 200 ms at the most.

However, to achieve such a rapid detection time, in the known process described above, the detection time of 600 to 700 ms cannot be easily reduced to 100 to 200 ms, since such a measure would increase the sensitivity of the process so greatly that even such rotational movements of the vehicle would be recognised as rolling or rollover movements, which in reality are not rolling or rollover movements at all. Safety measures would thus possibly be introduced unnecessarily.

### SUMMARY OF THE INVENTION

The object of the invention is to provide a process for assessing a rotational movement of a motor vehicle, which facilitates reliable detection of both slow and rapid rolling or rollover movements of the vehicle.

A process having the features of claim 1 is provided to achieve the object.

In the process of the invention for assessing a rotational movement, in particular a rolling or rollover movement, of a motor vehicle, the angular velocity of the vehicle is measured several times about at least one vehicle axis, in particular about the longitudinal axis, the horizontal transverse axis and/or the vertical transverse axis of the vehicle. The angular acceleration of the vehicle about the at least one vehicle axis is ascertained from two measured angular velocities, and the ascertained angular acceleration is taken into account when assessing the rotational movement.

In principle the rotational movement of a body is described by the following formula:
φ(t)=φ(0)+(ω·t)+(½(α·t²)) (1)
wherein φ(t) is the angular position at the point in time t, ω is the angular velocity

$$( \frac{δ φ}{δ t} )$$

and α is the angular acceleration

$$( \frac{{ⅆ}^{2} φ}{ⅆ {t}^{2}} ) .$$

For temporally spaced measurements of the angular velocity, dt represents in each case the time interval between two sequential measurements of the angular velocity or the time interval from the last calculation of the angular position.

For slow or uniform changes of the angle of rotation φ(t), the third term of equation (1) may be ignored and the angle of rotation φ(t) approximated by the following formula:
φ(t)=φ(0)+(ω·t) (2)
Traditionally the rotational movement of a motor vehicle is ascertained on the basis of equation (2). The simplified equation (2) is completely adequate to recognise slow rolling or rollover movements.

For rapid rolling or rollover movements, for example due to intake of sand or in case of contact with a kerb edge, the angle of rotation may however grow exponentially within certain ranges.

According to the invention, a consideration also of the third term of equation (1), that is a consideration of the angular acceleration, is therefore intended in the assessment of the rotational movement of a motor vehicle.

This facilitates a particularly reliable assessment of the rotational movement. In particular a conclusion on the dangerousness of a rotational movement of the motor vehicle can be made particularly well from the power and duration of angular acceleration, as a result of which the safety of the vehicle occupants is considerably increased in the event of rollover of the vehicle.

The angular acceleration of the vehicle is ascertained according to the invention directly from the measured angular velocities, namely by the formation of the difference between two angular velocities preferably measured one after another. In other words, the angular acceleration is calculated from the change in velocity during a preset time interval, that is hence by the temporal derivative of the measured angular velocities.

To carry out the process of the invention, it is therefore not necessary to provide additional sensors for measurement of the angular acceleration in the vehicle. Rather, the measured data of the already existing sensors may be used to measure the angular velocity.

The process of the invention can thus be integrated easily into an existing vehicle safety system. Only a change of computing algorithm is necessary for this, in other words hence simple reprogramming of an appropriate evaluating unit.

According to an advantageous design of the process of the invention, the angular velocity and the angular acceleration are ascertained at least at times periodically with a period T1.

The length of the period T1 is preferably selected to be particularly short and corresponds ideally to the time interval, in which the measured values of the velocity sensors are queried. However, the length of the period T1 may also be a multiple of this interval. So that the recognition of a rolling or rollover movement may take place in about 100 ms to 200 ms, the length of the period T1 should however not be more than a few 10 ms.

As has already been mentioned, the angular acceleration is calculated from the difference between two angular velocities, which have been measured with an interval of one period length. To be correct, the velocity difference must be divided by the length of the period T1 to calculate the acceleration. For a constant period length T1, it is however simpler to define the length of the period T1 as “1”. An angular acceleration standardised to the length of the period T1 is calculated in this manner.

According to a further advantageous embodiment, a counter contributing to the assessment of the rotational movement is raised when the angular acceleration of a period T1 exceeds a threshold value. Correspondingly the counter may be lowered when the angular acceleration of a period T1 does not reach the threshold value.

After each ascertaining of the angular acceleration, the ascertained angular acceleration is thus compared with a threshold value and a check is made whether the ascertained angular acceleration exceeds or does not reach the threshold value. Each time the threshold value is exceeded, the counter is raised and/or when the threshold value is not reached it is lowered. In other words, the counter is a measure of how often the ascertained angular acceleration has exceeded or has not reached the threshold value. The counter is thus an indicator of the power and duration of the ascertained angular acceleration.

The raising and/or lowering of the counter may take place in each case by a preset fixed, in particular whole-number, amount.

However, the raising and/or lowering of the counter preferably takes place in each case by a preset, in particular whole-number, amount, the size of which depends on the deviation of the ascertained angular acceleration from the threshold value.

For example, the counter may be raised or lowered for low exceeding or not reaching the threshold value by the value “1”, for medium exceeding or not reaching the threshold value by the value “2” and for particularly high exceeding or not reaching the threshold value by the value “4”. The preceding values are mentioned purely by way of example and may also be selected to be different according to the application. Equally it is possible to subdivide the measured angular accelerations into fewer or more categories than the said categories “low”, “medium” and “high”. Furthermore, it is possible to fix the said categories and/or values for exceeding the threshold value and for not reaching the threshold value to be different.

Due to the raising or lowering of the counter adapted to the degree of deviation of angular acceleration from the threshold value, the power of the measured angular acceleration is taken into account in a particular manner. High angular accelerations may thus be detected particularly rapidly. This facilitates an even more rapid recognition of a dangerous rolling or rollover movement and hence an even earlier activation of the vehicle safety system.

Alternatively, the raising and/or lowering of the counter may be proportional to the deviation of the ascertained angular acceleration from the threshold value. Also in this variant, the degree of deviation of the ascertained angular acceleration from the threshold value has a direct effect on the extent of raising or lowering the counter. This variant thus facilitates likewise particularly rapid recognition of a dangerous angular acceleration and hence in the end increased safety of the vehicle occupants.

The rotational movement is preferably graded as critical when the counter exceeds a predetermined counter threshold value. The counter threshold value fixes how long the ascertained angular velocities of a certain power remain insignificant or from when they are graded as dangerous.

Hence, the counter threshold value may be exceeded when the ascertained angular accelerations only slightly exceed or temporarily even do not reach the preset threshold value over a period of time of several periods T1. This case occurs particularly during slow rotational movements. By corresponding fixing of the counter threshold value, slow rolling or rollover movements may thus also be recognised early.

If the counter is raised as a function of the degree of deviation of the angular acceleration from the threshold value, the counter may already exceed the counter threshold value, for appropriate power of angular acceleration and for appropriate presetting of the step widths, by which the counter is raised, even after a few, for example one or two, periods T1. Hence, rapid rolling or rollover movements can also be detected in good time and appropriate safety measures can be introduced early.

According to a further advantageous design of the process of the invention, in addition a second angular acceleration is ascertained from two angular velocities, which define a time interval T2, which is a whole-number multiple of the period T1.

The angular velocity and the angular acceleration are ascertained on the one hand thus periodically with a period T1, and on the other hand a second angular acceleration is additionally ascertained over several periods T1. A periodic determination of two angular accelerations thus takes place over time windows of different length.

Short-term variations of the first ascertained angular acceleration, which may be caused, for example by errors during the measurement of the first angular velocities, remain unconsidered due to ascertaining the second change in angular velocity over a longer period of time. This ensures that the ascertained angular accelerations are not artefacts, but in fact are caused by a rolling or rollover movement of the vehicle.

The rotational movement is preferably is graded as critical when both the second angular acceleration and each first angular acceleration ascertained within the time interval T2 in each case exceeds a predetermined threshold value. The threshold values for the first and the second angular acceleration may be selected to be the same or different, wherein in the latter case, the threshold value for the first angular acceleration should be selected to be preferably somewhat lower than the threshold value for the second angular acceleration.

Due to the fact that the rotational movement is only graded as critical when all angular accelerations, that is, both all first angular accelerations and the second angular acceleration, exceed their particular threshold value, it is ensured that without exception relevant rotational movements are graded as dangerous. This increases the reliability of recognition of a rolling or rollover movement and prevents unnecessary activation of the vehicle safety system.

A further object of the invention is a process for activating a vehicle safety system, in which the vehicle safety system is activated when a rotational movement of a motor vehicle detected by a process according to claim 7 or 9 about a vehicle axis, in particular about the longitudinal axis, the horizontal transverse axis and/or the vertical transverse axis of the vehicle, is graded as critical.

Since the activation of the vehicle safety system is based on the process of the invention for assessing the rotational movement of the motor vehicle, the above-mentioned advantages apply accordingly.

Due to the fact that the assessment of a rotational movement of the motor vehicle takes place particularly rapidly according to the invention and therefore both slow and rapid rolling or rollover movements of the vehicle can be detected, the vehicle safety system is activated early both for a slow and for a rapid rolling or rollover movement of the vehicle. In both cases, safety measures may be introduced in good time for the protection of the vehicle occupants, as a result of which the safety of the vehicle occupants is increased.

The vehicle safety system is advantageously only activated when in addition the angular velocity and/or the angular position of the vehicle with respect to the vehicle axis in each case lie or lies within a predetermined critical range. In other words, the ascertained angular accelerations do not represent the single criterion for activating the vehicle safety system, but also the angular velocity and/or the angular position of the vehicle would have to lie within a critical range. Unnecessary activation of the vehicle safety system is effectively avoided in this manner and the safety of the vehicle occupants still further increased.

According to a further embodiment, the vehicle safety system is only activated when in addition the angular acceleration, the angular velocity and/or the angular position of the vehicle with respect to the other vehicle axis or vehicle axes in each case lie or lies within a predetermined critical range. Optionally the rotational movement of the vehicle about all three vehicle axes and hence in all three spatial directions during activation of the vehicle safety system may thus be taken into account. Unnecessary activation of the vehicle safety system is thus even better avoided and the safety of the vehicle occupants still further increased.

A further object of the invention is also a device for assessing a rotational movement, in particular a rolling or rollover movement, of a motor vehicle, having at least one sensor for measuring the angular velocity of the vehicle about a vehicle axis, in particular about the longitudinal axis, the horizontal transverse axis or the vertical transverse axis of the vehicle, a computing unit connected to the sensor to ascertain the angular acceleration of the vehicle about the at least one vehicle axis from two measured angular velocities, a comparator unit connected to the computing unit to compare the ascertained angular acceleration with a preset threshold value, and an evaluating unit connected to the comparator unit to evaluate a deviation of the ascertained angular acceleration from the threshold value.

The processes of the invention can be carried out using the device of the invention and the advantages associated therewith achieved.

The computing unit for ascertaining the angular acceleration, the comparator unit and the evaluating unit may be in each case separate units, however they are preferably combined in a central computing unit.

The raising and/or lowering of a counter contributing to the assessment of the rotational movement is preferably carried out in the evaluating unit.

Alternatively, first and second angular accelerations may be ascertained over in each case time intervals of different length, that is, having different period lengths T1 and T2, in the computing unit, compared with preset threshold values in the comparator unit and corresponding deviations from the threshold value are evaluated in the evaluating unit.

### BRIEF DESCRIPTION OF THE DRAWINGS

The invention is described below purely by way of example using an advantageous embodiment with reference to the attached drawings.

FIG. 1 shows a flow diagram of one embodiment of the process of the invention for assessing a rotational movement of a motor vehicle; and

FIG. 2 shows a flow diagram of one embodiment of the process of the invention for activating a vehicle safety system.

### DESCRIPTION OF THE PREFERRED EMBODIMENT

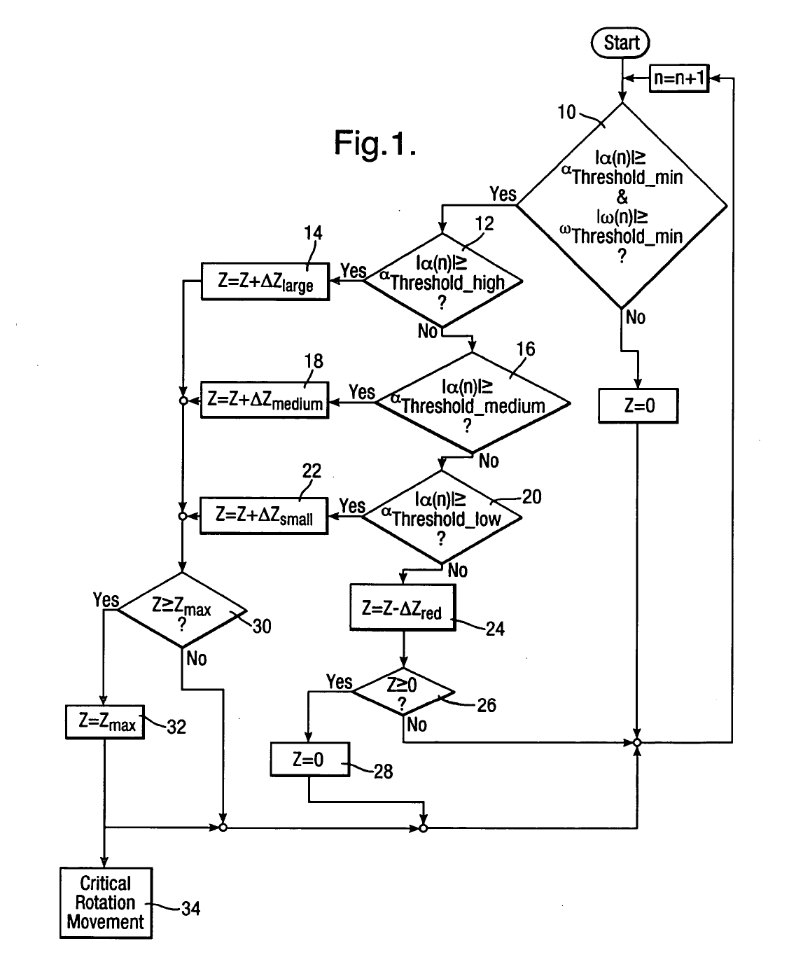

The process shown in FIG. 1 for assessing a rotational movement of a motor vehicle is based on the evaluation of a counter Z, which is always raised when an angular acceleration α(n) ascertained from measured angular velocities ω(n) exceeds a preset threshold value, and which is always lowered when the angular acceleration does not reach the threshold value.

In the present exemplary embodiment, only the rotational movement of the motor vehicle about its longitudinal axis (X axis) is assessed. In addition however, the rotational movement may also be assessed about the lateral transverse axis (Y axis) and/or about the vertical transverse axis (Z axis) of the motor vehicle. Only corresponding sensors thus have to be provided for measuring the angular velocity about the Y axis or Z axis. Ascertaining the angular acceleration and the assessment of the rotational movement of the motor vehicle about the Y axis or Z axis then take place according to the process described below.

The process is started when activating the motor vehicle, for example by switching on the motor. At the start of the process, initialisation of the counter Z takes place, by means of which the counter Z is returned to the value “0”.

The rotational velocity of the motor vehicle about the longitudinal axis (X axis) of the motor vehicle is measured at regular time intervals, in the present exemplary embodiment every 10 ms, by means of a suitable velocity sensor. Measurement of the rotational velocity thus takes place periodically with a period length T1, which is 10 ms in the present case. Each period T1 defines a computing step n, in which the angular acceleration α(n) of the motor vehicle about its longitudinal axis is ascertained from in each case two sequential measured angular velocities ω(n) and ω(n−1).

The angular acceleration α(n) is thus understood to mean the change in angular velocity over the period of time of a period T1. To simplify the computing effort, the assessment of the rotational movement takes place using standardised angular accelerations, that is, the angular accelerations are not calculated as velocity changes per unit of time, but per period length T1, which is fixed to the value “1” for the sake of simplicity. Thus in the end the difference between angular velocities ω(n) and ω(n−1) in each case measured one after another serves as a measure of angular acceleration.

As soon as an angular velocity ω(n) has been measured in an n^{th} computing step and the associated angular acceleration α(n) has been ascertained, a check is made in a process step 10 whether the amount of ascertained angular acceleration α(n) exceeds a preset minimum threshold α_{threshhold}_{_{—}}ₘᵢₙ. At the same time a check is made whether the amount of the corresponding angular velocity ω(n) exceeds a predetermined minimum threshold ω_{threshold}_{_{—}}ₘᵢₙ.

Provided the angular acceleration α(n) and/or the angular velocity ω(n) remains below its particular threshold value, the counter Z is left at its initial value “0” or returned to “0” and in a next computing step n+1, the enquiry of angular velocity and ascertaining the angular acceleration repeated.

On the other hand, if both the measured angular velocity ω(n) and the ascertained angular acceleration α(n) exceeds its particular threshold value ω_{threshold}_{_{—}}ₘᵢₙ or α_{teshhold}_{_{—}}ₘᵢₙ, the counter Z is altered.

For this purpose in a process step 12, a check is next made whether the amount of the ascertained angular acceleration α(n) exceeds a high threshold value α_{threshhold}_{_{—}}_{high}. If this is the case, the counter Z is raised in a process step 14 by a large value ΔZ_{large}.

However, if the ascertained angular acceleration α(n) does not exceed the high threshold value α_{threshhold}_{_{—}}_{high}, a check is next made in a process step 16 whether the amount of angular acceleration α(n) exceeds a medium threshold value α_{threshhold}_{_{—}}_{medium}. If this is the case, the counter Z is raised in a process step 18 by a medium value ΔZ_{medium}.

If the amount of the ascertained angular acceleration α(n) also does not exceed the medium threshold value α_{threshhold}_{_{—}}_{medium}, a check is next made in a process step 20 whether the amount of angular acceleration α(n) exceeds a predetermined low threshold value α_{threshhold}_{_{—}}_{low}. If this is the case, the counter Z is raised in a process step 22 by a small value ΔZₛₘₐₗₗ.

If the amount of ascertained angular acceleration α(n) also does not exceed the low threshold value α_{threshhold}_{_{—}}_{low}, the counter Z is reduced in a process step 24 by a preset amount ΔZ_{red}.

In this case, a check is made in a subsequent process step 26, whether the counter Z has become less than “0” due to the reduction. If this is the case, the counter Z is returned to “0” in a process step 28. On the other hand, if the counter Z has remained positive after reduction in step 24, it retains its current value and transfers the latter to the next computing step n+1.

In the case of raising the counter Z according to one of steps 14, 18 or 22, a check is made in a process step 30 whether the counter Z exceeds a counter threshold value Zₘₐₓ. If this is not the case, the counter Z retains its current value, and the process is continued in the next computing step n+1 with the process step 10.

On the other hand, if in process step 30 exceeding of the counter threshold value Zₘₐₓ is established, the threshold value Zₘₐₓ is assigned to the counter Z in a process step 32.

Exceeding the counter threshold value Zₘₐₓ leads to the rotational movement of the motor vehicle being graded as critical in a process step 34. It is an indicator of a dangerous rolling or rollover movement of the vehicle.

A critical rotational movement may be caused, firstly due to a particularly high angular acceleration α(n) within a period T1 or within few periods T1, that is, due to a short-term high angular acceleration, and secondly, due to smaller angular accelerations α(n), which occur over several periods T1, that is, thus due to a longer-lasting, lower acceleration.

The minimum threshold ω_{threshold}_{_{—}}ₘᵢₙ. for the angular velocity ω(n) may be, for example 20°/s to 40°/s. One possible value for the minimum threshold α_{threshhold}_{_{—}}ₘᵢₙ of the angular acceleration α(n) standardised to the period length T1 lies, for example between 0°/s, 1°/s and 2°/s.

In contrast, the low acceleration threshold value α_{threshhold}_{_{—}}_{low} may lie between 1°/s and 5°/s, the medium acceleration threshold value α_{threshhold}_{_{—}}_{medium} between 2°/s and 8°/s and the high acceleration threshold value α_{threshhold}_{_{—}}_{high} between 5°/s and 10°/s.

As already mentioned, the angular accelerations α(n) in the embodiment of the process shown are standardised to a period length T1 of “1”. The above-mentioned threshold values of acceleration therefore have in the present exemplary embodiment the same physical unit as the angular velocity, that is °/s.

For example the values 1, 2 and 4 are suitable as possible values for the amounts ΔZₛₘₐₗₗ, ΔZ_{medium} and ΔZ_{large}, by which the counter Z is raised in each case for a corresponding exceeding of the threshold value.

The reduction of the counter Z in the event of not reaching the threshold value α_{threshhold}_{_{—}}_{low} may take place, for example by the value ΔZ_{red}=1. One possible value for the counter threshold value Zₘₐₓ lies between 8 and 20.

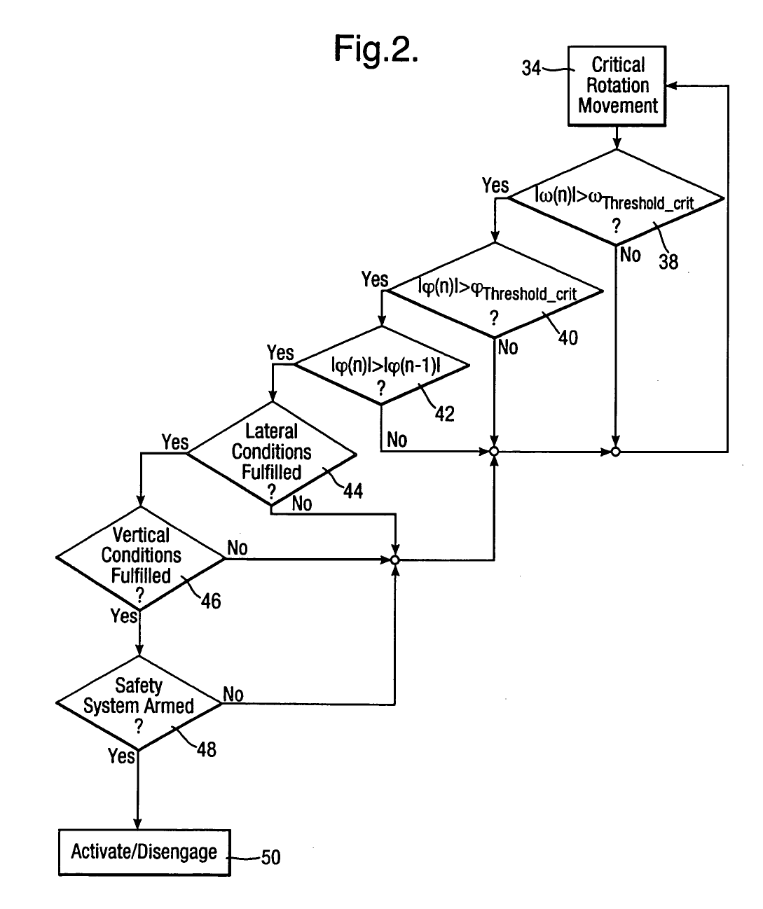

As soon as the counter Z exceeds the preset counter threshold value Zₘₐₓ in the process step 32 and the rotational movement of the motor vehicle is graded as critical in the process step 34, a process for activating a vehicle safety system is introduced (FIG. 2).

In this process, first of all a check is made in a process step 38 whether the amount of angular velocity ω(n) is greater than a preset critical velocity threshold ω_{threshold}_{_{—}}_{crit}.

If the amount of the measured angular velocity ω(n) lies below the critical velocity threshold ω_{threshold}_{_{—}}_{crit}, a check is made in the next computing step n+1 whether a critical rotational movement still exists and optionally the comparison of the measured angular velocity ω(n+1) with the critical angular velocity threshold value ω_{threshold}_{_{—}}_{crit} repeated.

On the other hand, if the angular velocity ω(n) exceeds the preset critical angular velocity threshold value ω_{threshold}_{_{—}}_{crit}, a check is next made in a process step 40 whether the amount of ascertained angular position φ(n) of the motor vehicle is greater (40) than a preset critical threshold value φ_{threshold}_{_{—}}_{crit}.

If this is not the case, the process is repeated starting with step 34 in the next computing step n+1.

On the other hand, if the ascertained angular position φ(n) is greater than the preset critical threshold value φ_{threshold}_{_{—}}_{crit}, a check is next made in a process step 42 whether the angular position φ(n) of the current computing step n is greater than the angular position φ(n−1) of the previous computing step, that is, a check is made whether the angle of rotation of the vehicle has been increased compared to the angle of rotation of the last period T1.

If this is the case, a check is next made in a process step 44 whether predetermined lateral conditions are fulfilled. These lateral conditions may be, for example the velocity and/or acceleration of the motor vehicle in Y direction. If these predetermined lateral conditions are not fulfilled, the process is continued in the next computing step n+1 with step 34.

On the other hand, if the lateral conditions are fulfilled, a check is next made in a process step 46 whether in addition predetermined vertical conditions are also fulfilled. Corresponding to the lateral conditions, the vertical conditions may be the velocity and/or acceleration of the vehicle in Z direction.

If these vertical conditions are not fulfilled, it is also true here that the process is continued in the next computing step n+1 with the process step 34.

On the other hand, if the vertical conditions are fulfilled, a check is made in a next process step 48 whether the vehicle safety system is live. If the vehicle safety system is not live, the process starts again in the following computing step n+1 with the process step 34.

On the other hand, if the vehicle safety system is situated in a live state, it is activated in a process step 50. By activating the vehicle safety system, suitable measures for the protection of the vehicle occupants may be introduced in the case of a dangerous rolling or rollover movement of the vehicle. For example a roll bar may be brought into position, a reinforced neck support moved out and/or an airbag triggered.

1. A process for assessing a rotational movement, in particular a rolling or rollover movement, of a motor vehicle, in which the angular velocity of the vehicle is measured several times about at least one vehicle axis, in particular about the longitudinal axis, the horizontal transverse axis and/or the vertical transverse axis of the vehicle, the angular acceleration of the vehicle about the at least one vehicle axis is ascertained from two measured angular velocities, and the ascertained angular acceleration is taken into account when assessing the rotational movement.

2. The process of claim 1, characterised in that the angular velocity and the angular acceleration are ascertained at least at times periodically with a period T1.

3. The process of claim 1, characterised in that a counter contributing to the assessment of rotational movement is raised when the angular acceleration of a period T1 exceeds a threshold value and/or the counter is lowered when the angular acceleration of a period T1 does not reach the threshold value.

4. The process of claim 3, characterised in that the raising and/or lowering of the counter takes place by a preset fixed, in particular whole-number, amount.

5. The process of claim 3, characterised in that the raising and/or lowering of the counter takes place by a preset, in particular whole-number, amount, the size of which depends on the deviation of the ascertained angular acceleration from the threshold value.

6. The process of claim 3, characterised in that the raising and/or lowering of the counter is proportional to the deviation of the ascertained angular acceleration from the threshold value.

7. The process of claim 3, characterised in that the rotational movement is graded as critical when the counter exceeds a predetermined counter threshold value.

8. The process of claim 2, characterised in that in addition a second angular acceleration is ascertained from two angular velocities, which define a time interval T2, which is a whole-number multiple of the period T1.

9. The process of claim 8, characterised in that the rotational movement is graded as critical when both the second angular acceleration and each first angular acceleration ascertained within the time interval T2 in each case exceeds a predetermined threshold value.

10. The process of claim 9, wherein a vehicle safety system is activated when a rotational movement of a motor vehicle detected by the process about a vehicle axis, in particular about the longitudinal axis, the horizontal transverse axis and/or the vertical transverse axis of the vehicle, is graded as critical.

11. The process of claim 10, characterised in that the vehicle safety system is only activated when in addition the angular velocity and/or the angular position of the vehicle with respect to the vehicle axis in each case exceed or exceeds a predetermined critical threshold value.

12. The process of claim 10, characterised in that the vehicle safety system is only activated when in addition the angular acceleration, the angular velocity and/or the angular position of the vehicle with respect to the other vehicle axis or vehicle axes in each case lie or lies within a predetermined critical range.

13. A device for assessing a rotational movement, in particular a rolling or rollover movement, of a motor vehicle, having at least one sensor for measuring the angular velocity of the vehicle about a vehicle axis, in particular about the longitudinal axis, the horizontal transverse axis or the vertical transverse axis of the vehicle, a computing unit connected to the sensor to ascertain the angular acceleration of the vehicle about the vehicle axis from two measured angular velocities, a comparator unit connected to the computing unit to compare the ascertained angular acceleration with a preset threshold value, and an evaluating unit connected to the comparator unit to evaluate a deviation of the ascertained angular acceleration from the threshold value.
